(19) United States
(12) Patent Application Publication
(10) Pub. No.: US 2022/0317867 A1
(43) Pub. Date: Oct. 6, 2022

(54) SYSTEM AND METHOD FOR CREATING AND PROGRESSING VISUAL INTERACTIVE STORIES ON COMPUTING DEVICES

(71) Applicants: VIDYA NARAYANAN, San Jose, CA (US); LAKSHMINATH REDDY DONDETI, San Jose, CA (US)

(72) Inventors: VIDYA NARAYANAN, San Jose, CA (US); LAKSHMINATH REDDY DONDETI, San Jose, CA (US)

(21) Appl. No.: 17/712,303

(22) Filed: Apr. 4, 2022

Related U.S. Application Data
(60) Provisional application No. 63/170,582, filed on Apr. 5, 2021.

(51) Int. Cl. G06F 3/04845; G06T 11/00; G06F 3/04883; H04L 65/1069; H04L 65/1089

(52) U.S. Cl. CPC G06F 3/04845; G06T 11/00; G06F 3/04883; H04L 65/1069; H04L 65/1089; G06T 2200/24; G06Q 30/0226

(57) ABSTRACT

Exemplary embodiments of the present disclosure are directed towards a system for creating and progressing visual interactive stories on computing devices comprising client device comprises first interactive story creation module configured to enable creator to upload first media content and identify first context. First interactive story creation module configured to suggest first digital graphical elements and enabled to add on first media content to create visual interactive story and shares to cloud server and end-user devices over network. End-user devices comprises second interactive story creation module configured to enable end-users to interact with visual interactive story. Second interactive story creation module configured to identify second context of end-users and suggests second digital graphical elements. Second interactive story creation module configured to enable end-users to progress visual interactive story by adding second digital graphical elements, second media content on visual interactive story and shares progressed visual interactive stories to cloud server.

### CROSS-REFERENCE TO RELATED APPLICATIONS

This patent application claims priority benefit of U.S. Provisional Patent Application No. 63/170,582, entitled “METHOD AND APPARATUS FOR VISUAL INTERACTIVE STORIES IN SOCIAL NETWORKS”, filed on 5 Apr. 2021. The entire contents of the patent application is hereby incorporated by reference herein in its entirety.

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever.

### TECHNICAL FIELD

The disclosed subject matter relates generally to sharing visual content in a social network. More particularly, the present disclosure relates to a system and computer implemented method for creating and progressing visual interactive stories on computing devices. The system enables a creator to capture a first media content on a client device and enables to add stickers and stamps or doodling on the first media content to create a visual interactive story. The system enables the creator to share the visual interactive story to end-users on end-user devices over a network. Further, the system enables the end-users to interact on the visual interactive story by adding a second media content, adding stickers and stamps or doodling on the visual interactive story, and adding rich expressions to the visual interactive story using gestures on the end-user devices to progress the visual interactive story on the end-user devices. The media content include photographs, audios, images, videos selected, generated or captured or combinations thereof. The system configured to perform an automatic group detection and management in the social networks.

### BACKGROUND

Generally, the conventional systems enables a creator to capture a multimedia content on a computing device in real-time, and allows to apply filters for color alteration to compose a story. The conventional systems also enable the creator to upload the multimedia content (photos or videos) from the memory of the computing device to create the story. The conventional systems enable the creator to share the story in social networks. However, the conventional systems do not allow a content viewer to interact on the story by adding photos and videos to the story, adding stickers and stamps on photos or videos or doodling on photos or videos. Further, the interactions take place in today's social networks with a fixed set of reactions and comments.

Now-a-days, the existing systems detects contacts saved on the computing device and suggest the creator to share the story conveniently. The existing systems fails to detect the group of friend automatically to share the story conveniently in future. The existing systems also to save a group for the members of the group to share stories conveniently with the same group of people in future. However, the existing systems also fails to detect and to remove an inactive group automatically after a certain period of inactivity. Hence, there is a need to develop a system and method for creating and progressing visual interactive stories on computing devices.

In the light of the aforementioned discussion, there exists a need for a certain system with novel methodologies that would overcome the above-mentioned challenges.

### SUMMARY

The following invention presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

An objective of the present disclosure is directed towards system and computer implemented method for creating and progressing visual interactive stories on computing devices.

Another objective of the present disclosure is directed towards enabling the creator to create a visual interactive story using a first media content on a client device.

Another objective of the present disclosure is directed towards enabling the creator to capture the first media content on the client device using a first camera in real-time.

Another objective of the present disclosure is directed towards enabling the creator to share the visual interactive story to a group of end-users on the end-user devices over a network.

Another objective of the present disclosure is directed towards enabling the end-users to interact on the visual interactive story by adding a second media content to the visual interactive story, adding stickers and stamps on the visual interactive story or doodling on the visual interactive story, and adding rich expressions to the visual interactive story using gestures on the end-user devices to progress the visual interactive story.

Another objective of the present disclosure is directed towards performing an automatic group detection and management in the social networks.

Another objective of the present disclosure is directed towards enabling the end-users to view the visual interactive story shared in public by all members of the social network or in private, and the visual interactive story is only viewable to the set of people with whom they have been explicitly shared.

Another objective of the present disclosure is directed towards the media content includes photographs, images, or videos selected, and/or any graphics or text associated with the media generated or captured on the computing device.

Another objective of the present disclosure is directed towards the system automatically detects the end-users interacting on the visual interactive story and saves as a group for the members of the end-users to share the visual interactive story conveniently with the same group of people in future.

Another objective of the present disclosure is directed towards the system detects the lack of activity among the group thereby eliminating the group automatically after a certain period of inactivity.

Another objective of the present disclosure is directed towards enabling the creators to create the visual interactive story and allowing to share the visual interactive story in private or in public of a social network.

Another objective of the present disclosure is directed towards sharing the visual interactive story to the cloud server thereby distributing the visual interactive story to the end-users.

Another objective of the present disclosure is directed towards calculating reward points and generating scores based on the visual interactive shared by the creator/the end-users and storing the visual interactive story in the cloud server along with relevant metadata.

According to an exemplary aspect of the present disclosure, a system comprising a client device and end-user devices configured to establish communication with a cloud server over a network.

According to another exemplary aspect of the present disclosure, the client device comprises a first processor, a first memory, a first camera, a first display, a first audio output, and a first audio input.

According to another exemplary aspect of the present disclosure, the first processor comprises a first interactive story creation module and is stored in the first memory of the client device the first interaction story creation module configured to enable a creator to capture a first media content in real-time using the first camera, and the first audio input.

According to another exemplary aspect of the present disclosure, the first interactive story creation module configured to enable the creator to upload at least one of the first media content stored in the first memory of the client device; and the first media content captured in real-time.

According to another exemplary aspect of the present disclosure, the first interactive story creation module configured to identify a first context of the creator and suggests first digital graphical elements on the client device.

According to another exemplary aspect of the present disclosure, the first interactive story creation module also configured to enable the creator to add the first digital graphical elements on the first media content to create a visual interactive story and shares the visual interactive story to the cloud server and the end-user devices over the network.

According to another exemplary aspect of the present disclosure, the end-user devices comprises a second interactive story creation module configured to display the visual interactive story shared by the creator from the client device and enables end-users to interact with the visual interactive story on the end-user devices.

According to another exemplary aspect of the present disclosure, the second interactive story creation module configured to enable the end-users to upload at least one of a second media content stored in a second memory of the end-user devices; and the second media content captured in real-time.

According to another exemplary aspect of the present disclosure, the second interactive story creation module configured to identify a second context of the end-users and suggests second digital graphical elements to the end-users on the on end-user devices.

According to another exemplary aspect of the present disclosure, the second interactive story creation module configured to enable the end-users to progress the visual interactive story by adding at least one of the second digital graphical elements; and the second media content; on the visual interactive story shared by the creator.

According to another exemplary aspect of the present disclosure, progressing visual interactive stories on the end-user devices and shares the progressed visual interactive stories to the cloud server over the network.

### BRIEF DESCRIPTION OF THE DRAWINGS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

FIG. 1 is a block diagram depicting a schematic representation of a system and method to create and progress visual interactive stories on computing devices, in accordance with one or more exemplary embodiments.

FIG. 2 is a block diagram depicting an embodiment of the first interactive story creation module and the second interactive story creation module of shown in FIG. 1, in accordance with one or more exemplary embodiments.

FIG. 3 is a flow diagram depicting a method for creating a visual interactive story on a client device, in accordance with one or more exemplary embodiments.

FIG. 4 is a flow diagram depicting a method for interacting on the visual interactive story, in accordance with one or more exemplary embodiments.

FIG. 5 is a flow diagram depicting a method for dynamically detecting and creating a group from the interactions on the visual interactive stories happening among a group of people, in accordance with one or more exemplary embodiments.

FIG. 6 is a flow diagram depicting a method for dynamically detecting and expiring the inactive groups or updating the groups based on the new interactions, in accordance with one or more exemplary embodiments.

FIG. 7 is a flow diagram depicting a method for expressing deep likes on the visual interactive story shared with the end-users, in accordance with one or more exemplary embodiments.

FIG. 8 is a flow diagram depicting a method for sharing rich expressions on the visual interactive story with the gestures and replaying the expressions to the end-users, in accordance with one or more exemplary embodiments.

FIG. 9 is a flow diagram depicting a method for creating and progressing a visual interactive story on computing devices, in accordance with one or more exemplary embodiments.

FIG. 10 is a block diagram illustrating the details of a digital processing system in which various aspects of the present disclosure are operative by execution of appropriate software instructions.

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and so forth, herein do not denote any order, quantity, or importance, but rather are used to distinguish one element from another.

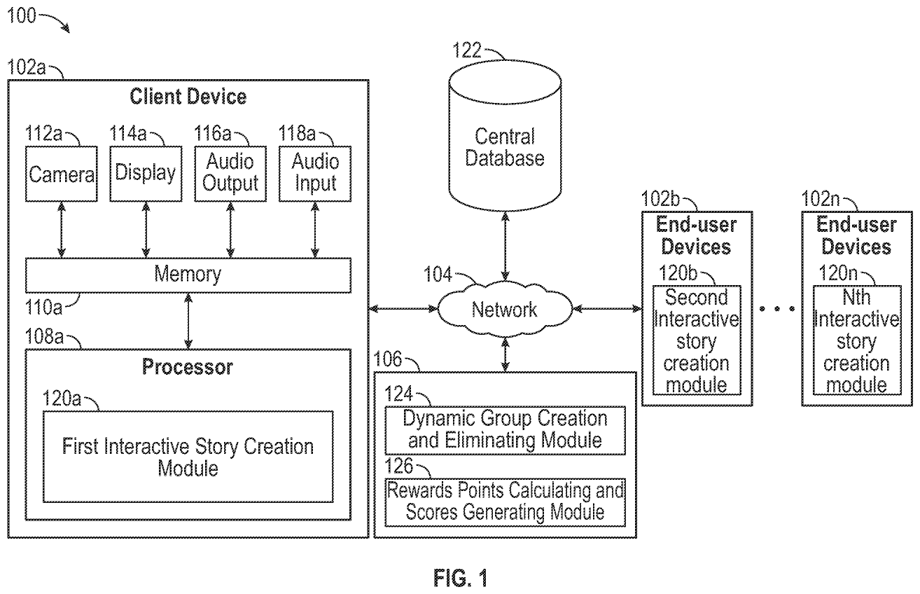

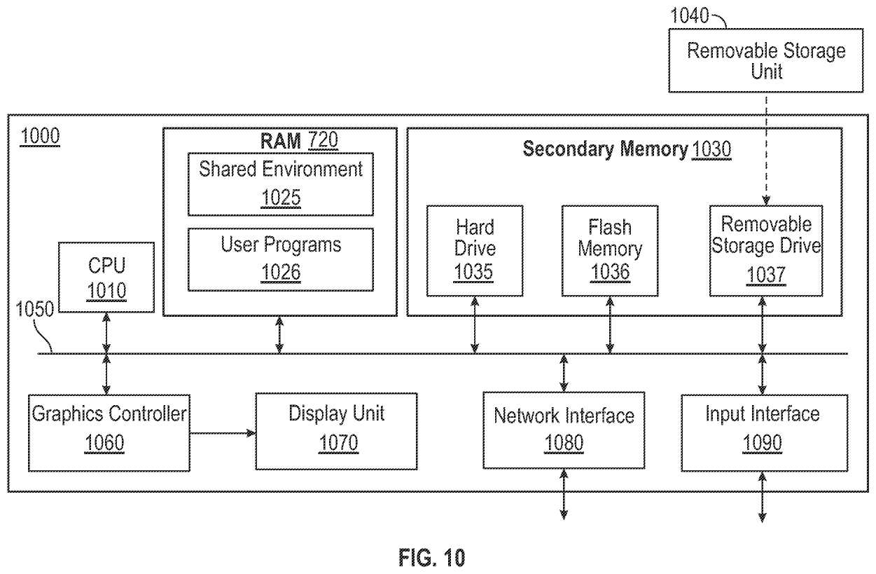

Referring to FIG. 1 is a block diagram 100 depicting a schematic representation of a system and method to create and progress visual interactive stories on computing devices, in accordance with one or more exemplary embodiments. The system 100 includes a client device 102a, end-user devices 102b, 102c . . . 102n, a network 104, a cloud server 106, and a central database 122. The client device 102a may include a first processor 108a, a first memory 110a, a first camera 112a, a first display 114a, a first audio output, 116a, and a first audio input 118a. The first processor 104a may be a central processing unit and/or a graphics processing unit (As shown in FIG. 10). The first memory 110a of the client device 102a may include a first interactive story creation module 120a. The end-user devices 102b, 102c . . . 102n may include a second processor, a second memory, a second camera, a second display, a second audio output, and a second audio input. The second memory of the end-user devices 102b, 102c . . . 102n may include a second interactive story creation module 120b. The cloud server 106 includes a dynamic group creation module 124, reward points calculating and score generating module 126.

The client device 102a may be connected to the one or more end-user devices 102b, 102c . . . 102n (computing devices) via the network 104. The client device 102a/the end-user devices 102b, 102c . . . 102n may include, but is not limited to, a personal digital assistant, smartphones, personal computers, a mobile station, computing tablets, a handheld device, an internet enabled calling device, an internet enabled calling software, a telephone, a mobile phone, a digital processing system, and so forth. The network 104 may include, but not limited to, an Internet of things (IoT network devices), an Ethernet, a wireless local area network (WLAN), or a wide area network (WAN), a Bluetooth low energy network, a ZigBee network, a WWI communication network e.g., the wireless high speed internet, or a combination of networks, a cellular service such as a 4G (e.g., LTE, mobile WiMAX) or 5G cellular data service, a RFID module, a NFC module, wired cables, such as the world-wide-web based Internet, or other types of networks may include Transport Control Protocol/Internet Protocol (TCP/IP) or device addresses (e.g. network-based MAC addresses, or those provided in a proprietary networking protocol, such as Modbus TCP, or by using appropriate data feeds to obtain data from various web services, including retrieving XML data from an HTTP address, then traversing the XML for a particular node) and so forth without limiting the scope of the present disclosure. The network 104 may be configured to provide access to different types of end-users.

The first interactive story creation module 120a on the client device 102a and the second interactive story creation module 120b on the end-user devices 102b, 102c . . . 102n are accessed as a mobile application, web application, software that offers the functionality of accessing mobile applications, and viewing/processing of interactive pages, for example, are implemented in the client device 102a/the end-user devices 102b, 102c . . . 102n, as will be apparent to one skilled in the relevant arts by reading the disclosure provided herein. For example, the first interactive story creation module 120a, and the second interactive story creation module 120b may be any suitable application downloaded from GOOGLE PLAY® (for Google Android devices), Apple Inc.'s APP STORE® (for Apple devices), or any other suitable database, server, webpage or uniform resource locator (URL). The first interactive story creation module 120a, and the second interactive story creation module 120b which may be a desktop application which runs on Mac OS, Microsoft Windows, Linux or any other operating system, and may be downloaded from a webpage or a CD/USB stick etc. In some embodiments, the first interactive story creation module 120a, and the second interactive story creation module 120b may be software, firmware, or hardware that is integrated into the client device 102a and the end-user devices 102b, 102c . . . 102n.

Although the client device 102a and the end-user devices 102b, 102c . . . 102n shown in FIG. 1, an embodiment of the system 100 may support any number of computing devices. The client device 102a may be operated by a creator. The creator may include, but not limited to, an initiator, an individual, a client, an operator, a user, a story creator, and so forth. The end-user devices 102b, 102c . . . 102n may be operated by the multiple end-users. The end-users may include, but not limited to, family members, friends, relatives, group members, public, media viewers, and so forth. The client device 102a and the end-user devices 102b, 102c . . . 102n supported by the system 100 is realized as a computer-implemented or computer-based device having the hardware or firmware, software, and/or processing logic needed to carry out the computer-implemented methodologies described in more detail herein.

In accordance with one or more exemplary embodiments of the present disclosure, the first interactive story creation module 120a may be configured to enable the creator to create the visual interactive story using the first media content stored in the first memory 110a of the client device 102a. The first media content may include, but not limited to, photographs, audios, images, videos selected, generated or captured or combinations thereof. The first interactive story creation module 120a may be configured to enable the creator to create the visual interactive story by uploading the first media content stored in the first memory 110a of the client device 102a or by capturing the first media content in real-time using the first camera 112a and/or the first audio input 118a of the client device 102a.

The first interactive story creation module 120a may be configured to detect the first context of the creator and suggest/display the first digital graphic elements to the creator based on the first context of the creator, user profile, availability of sponsored canvases, general context (e.g., day of the week, new movie releases, TV shows, etc.) and so forth. The first context may include, but not limited to, a personal place of relevance to the creator such as home, work, class, dentist and so forth, a general place of interest such as restaurant, theater, gym, mall, monument, and so forth, an activity such as watching TV, running, driving, taking pictures, shopping, and so forth, people nearby such as friends, crowds, and so forth, and the ambience of the creator environment such as bright, dark, day, night, loud, quiet, and so forth. The word sponsored in the context may include a person, a group, a merchant, business, trademark owner, brand owner or other similar entity may champion the display of specific multimedia content (a photograph, image, video, animated image, animated set of images, looping videos, looping images). The first digital graphical elements may include, but not limited to, canvases, stamps, stickers, filters doodle, and so forth. The first digital graphic elements may be in a static format, an animated format, a dynamic format, video graphic format and other related renditions and formats. The first interactive story creation module 120a may be configured to enable the creator to add the first digital graphical elements on the first media content to create the visual interactive story. The first interactive story creation module 120a may be configured to enable the creator to share the visual interactive story with the end-user devices 102b, 102c . . . 102n and the cloud server 106 over the network 104.

In accordance with one or more exemplary embodiments of the present disclosure, the second interactive story creation module 120b may be configured to receive the visual interactive story shared by the creator from the client device 102a over the network 104. The second interactive story creation module 120b may be enable the end-users to interact with the visual interactive story shared to the end-user devices 102b, 102c . . . 102n from the client device 102a.

The second interactive story creation module 120b may be configured to enable the end-users to interact with the visual interactive story on the end-user devices 102b, 102c . . . 102n by adding the second media content to the visual interactive story. The second media content may be stored in the second memory of the end-user devices 102b, 102c . . . 102n. The second media content may include, but not limited to, photographs, audios, images, videos selected, generated or captured or combinations thereof. The second interactive story creation module 120b may be configured to detect the second context of the end-users and suggest/display the second digital graphic elements based on the end-user profile, the second context of the end-users, availability of sponsored canvases, general context (e.g., day of the week, new movie releases, TV shows, etc.) or other criteria. The second context may include, but not limited to, a personal place of relevance to the end-user such as home, work, class, dentist and so forth, a general place of interest such as restaurant, theater, gym, mall, monument, and so forth, an activity such as watching TV, running, driving, taking pictures, shopping, and so forth, people nearby such as friends, crowds, and so forth, and the ambience of the end-user's environment such as bright, dark, day, night, loud, quiet, and so forth. The word sponsored in the context may include a person, a group, a merchant, business, trademark owner, brand owner or other similar entity may champion the display of specific multimedia content (a photograph, image, video, animated image, animated set of images, looping videos, looping images). The second digital graphical elements may include, but not limited to, canvases, stamps, stickers, filters doodle, and so forth. The second digital graphic elements may be in a static format, an animated format, a dynamic format, video graphic format and other related renditions and formats. The second interactive story creation module 120b may be configured to enable the end-users to add the second digital graphical elements, rich expressions to the visual interactive story using gestures to progress the visual interactive story.

In accordance with one or more exemplary embodiments of the present disclosure, the first interactive story creation module 120a may be configured to detect the group of end-users interacting on the visual interactive story and saves as a group for the creators to share the visual interactive stories conveniently with the same group of people in future. The first interactive story creation module 120b may be also configured to detect the lack of activity among the group of the end-users and removes the group automatically after a certain period of inactivity.

The first interactive story creation module 120a may be configured to enable the creator to capture the first media content using first camera 112a and/or to select the first media content detected on the client device 102a. The second interactive story creation module 120b may be configured to enable the end-users to capture second media content using the second camera on the end-user devices 102b, 102c . . . 102n and/or to select the second media content detected on the end-user devices 102b, 102c . . . 102n.

In accordance with one or more exemplary embodiments of the present disclosure, the first interactive story creation module 120a may be configured to enable the creator to create a number of first pre-designed digital graphic elements on the client device 102a and are stored in the cloud sever 106 and the central database 122. The first pre-designed digital graphic elements may be customized by the creator based on the first context of the creator. The creator may enter the date and venue of the events to customize the first pre-designed digital graphic elements. Examples of events may include, but not limited to, weddings, birthdays, anniversaries, concerts, book readings, date nights, girl's night out, and so forth.

The second interactive story creation module 120b may be configured to enable the end-users to create a number of second pre-designed digital graphic elements on the end-user devices 102b, 102c . . . 102n and are stored in the cloud sever 106 and the central database 122. The second pre-designed digital graphic elements may be customized by the end-users based on the second context of the end-users. The end-users may enter the date and venue of the events to customize the second pre-designed digital graphic elements. Examples of events may include, but not limited to, weddings, birthdays, anniversaries, concerts, book readings, date nights, girl's night out, and so forth. The first interactive story creation module 120a and the second interactive story creation module 120b may be configured to deliver the first pre-designed digital graphic elements and the second pre-designed digital graphic elements to the cloud server 106 and the central database 122 over the network 104.

The cloud server 106, and the central database 122 may be configured to store the user profiles of the creators and the end-users, the first context of the creators and the second context of the end-users, the first media content of the creators, the second media content of the end-users, the first digital graphical elements of the creators, the second digital graphical elements of the end-users, the first pre-designed digital graphical elements, the second pre-designed digital graphical elements and so forth.

In accordance with one or more exemplary embodiments of the present disclosure, the first interactive story creation module 120a may be configured to enable the creator to share the visual interactive story with one or more end-users. In an alternate embodiment, the visual interactive story may be shared with everyone on the first interactive story creation module 120a from the end-users. The first interactive story creation module 120a may offer suggestions of friends or groups of friends to share the visual interactive story with the end-users. The second interactive story creation module 120b may offer suggestions of friends or groups of friends to share the progressed visual interactive story with the end-users/the creator. These suggestions may be based on previous story shared, groups created, and first and second context of the user (e.g., where the user is, who is with the user, etc.), what is being shared and so forth.

The first interactive story creation module 120a may be configured to enable the creator on the client device 102a to distribute the visual interactive story to the selected end-users on the end-user devices 102c, 102b . . . 102n. The step of distributing involve sharing the visual interactive story from the client device 102a to the cloud server 106 may then distributes the visual interactive story to the other end-user devices 102b, 102c . . . 102n. The first interactive story creation module 120a may be configured to compute the visual interactive story and generates the reward points and scores to the creator on the client device 102a based on the visual interactive story shared to the end-users. The generated reward points and scores of the creator may be stored along with the relevant metadata in the cloud server 106. The metadata may include topics related to the first digital graphical elements used in the first story, when it was shared, with whom it was shared, the location from which it was shared and other data. The second interactive story creation module 120b may be configured to compute the visual interactive story and generates the reward points and scores to the end-users on the end-user devices 102b, 102c . . . 102n based on the visual interactive story shared to the end-users. The generated reward points and scores of the end-users may be stored along with the relevant metadata in the cloud server 106.

In accordance with one or more exemplary embodiments of the present disclosure, the cloud server 106 includes the dynamic group creation and eliminating module 124 may be configured to detect the visual interactive story shared with a group of end-users Further, the dynamic group creation and eliminating module 124 may be configured to detect the group of people interacting on the same visual interactive story or the visual interactive story with similar characteristics. The dynamic group creation and eliminating module 124 may be configured to compute a group composition based on these groups of interactions. The computing of group composition may include, a group composition may include detecting the groups of users who repeatedly interact on the same content, groups of users who interact directly with each other, the same group of users being part of shared visual interactive story multiple times and so on. The dynamic group creation and eliminating module 124 may be configured to retrieve any existing groups that have the same composition as the computed group. The dynamic group creation and eliminating module 124 may be configured to update the groups if there are matching groups based on computed group parameters, else creates a new group for the computed composition. The newly formed groups are then named. The dynamic group creation and eliminating module 124 may be configured to retrieve the common contexts for the computed group members to name the group. Common contexts may include anything two or more people in the computed group may have in common, a common city, a common city of residence in the past, common college, common high school, common interests, activities done together by the members, and so forth. Based on available data, the groups may be automatically named in any of the following formats includes Initials of group members, Funny name compositions and so forth, animal names with funny adjectives (e.g., “Embarrassing pandas”, “Jabbering Jaguars”, etc.), Names reflecting common context among group members, “Chicago friends”, “UC Girls”, “Fierce Five”, “High school squad”, “Ex-California squad”, “The biking group”, “Canada vacation troupe” The computed groups are distributed to all group members. Any reward points and scores based on actions done by the group members are computed and stored in the cloud server 106 along with relevant metadata. Metadata may include topics related to the filters or stickers or canvases used in the visual interactive story shared with the group, when it was shared, with whom it was shared, the location from which it was shared and other data.

The dynamic group creation and eliminating module 124 may be configured to detect an active group of end-users interacted to the visual interactive story and an inactive group of end-users not interacted with the visual interactive story shared by the creator thereby eliminating the inactive group of end-users on the client device 102a. The dynamic group creation and eliminating module 124 may be configured to detect a new visual interactive story shared among the group of end-users; and any new interactions among the group of end-users and marking the group of end-users as no longer marked for expiry.

In accordance with one or more exemplary embodiments of the present disclosure, the cloud server 106 includes the reward points calculating and scores generating module 126 may be configured to generate reward points and scores based on the computed visual interactive story shared with the end-users devices and stores the reward points and scores along with a relevant metadata in the cloud server 106. The reward points calculating and scores generating module 126 may be configured to compute reward points and scores based on actions performed by the group members and are stored along with relevant metadata. The reward points calculating and scores generating module 126 may be configured to compute reward points and scores based on likes to the corresponding visual interactive story and are stored along with relevant metadata.

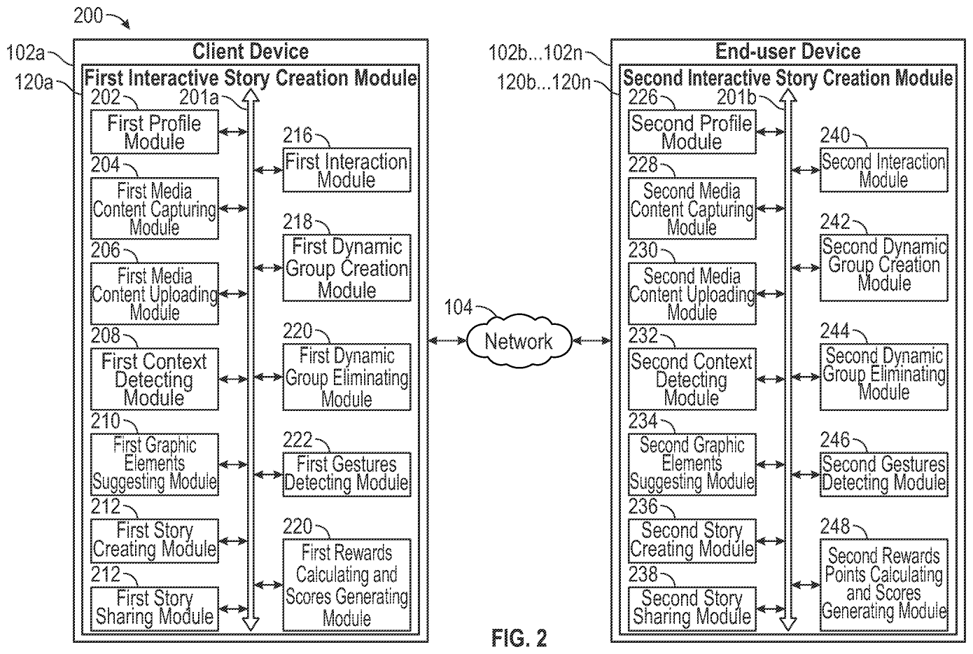

Referring to FIG. 2 is a block diagram 200 depicting an embodiment of the first interactive story creation module 120a and the second interactive story creation module of shown in FIG. 1, in accordance with one or more exemplary embodiments. The first interactive story creation module 120a includes a bus 201a, a first profile module 202, a first media content capturing module 204, a first media content uploading module 206, a first context detecting module 208, a first graphic elements suggesting module 210, a first story creating module 212, a first story sharing module 214, a first interaction module 216, a first dynamic group creation module 218, a first dynamic group eliminating module 220, first gestures detecting module 222, a first rewards calculating and scores generating module 224.

The bus 201a and 201b may include a path that permits communication among the modules of the first interactive story creation module 120a and the second story interaction module 120b installed on the client device 102a and the end-user devices 102b, 102c . . . 102n. The term “module” is used broadly herein and refers generally to a program resident in the memory of the client device 102a and the end-user devices 102b, 102c . . . 102n.

In accordance with one or more exemplary embodiments of the present disclosure, the first profile module 202 may be configured to enable the creator on the client device 102a to create the creator profile. The first profile module 202 may be configured to transmit the user profiles of the creators to the cloud server 106 and are stored in the cloud server 106.

The first media content capturing module 204 may be configured to enable the creator to capture the first media content in real-time. The first media content uploading module 206 may be configured to enable the creator to upload the first media content stored in the first memory 110a of the client device 102a. The first context detection module 208 may be configured to detect the first context of the creator on the client device 102a. The first graphic elements suggesting module 210 may be configured to suggest/displays the first graphical elements based on the first context of the creator, user profile, and availability of sponsored canvases, general context (e.g., day of the week, new movie releases, TV shows, etc.) and so forth. The word sponsored in the context may include a person, a group, a merchant, business, trademark owner, brand owner or other similar entity may champion the display of specific multimedia content (a photograph, image, video, animated image, animated set of images, looping videos, looping images). The first digital graphical elements may include, but not limited to, canvases, stamps, stickers, filters doodle, and so forth. The first digital graphic elements may be in a static format, an animated format, a dynamic format, video graphic format and other related renditions and formats. The first story creating module 212 may be configured to enable the creator to create the visual interactive story by uploading the first media content stored in the first memory 110a of the client device 102a or by capturing the first media content in real time using the first camera 112a. The first story sharing module 214 may be configured to enable the creator to share the visual interactive story with the end-user devices 102b, 102c . . . 102n and the cloud server 106 over the network 104.

In accordance with one or more exemplary embodiments of the present disclosure, the first dynamic group creation module 218 may be configured to enable the creator to share the visual interactive story with the selected group of the end-users. The first dynamic group creation module 218 may be configured to detect the visual interactive story shared with a group of end-users Further, the first dynamic group creation module 218 may be configured to detect the group of people interacting on the same visual interactive story or the visual interactive story with similar characteristics. The first dynamic group creation module 218 may be configured to compute a group composition based on these groups of interactions. The computing of group composition may include, a group composition may include detecting the groups of users who repeatedly interact on the same content, groups of users who interact directly with each other, the same group of users being part of shared visual interactive story multiple times and so on. The first dynamic group creation module 218 retrieve any existing groups that have the same composition as the computed group. The first dynamic group creation module 218 configured to update the groups if there are matching groups based on computed group parameters, else creates a new group for the computed composition. The newly formed groups are then named.

The first dynamic group creation module 218 may be configured to retrieve the common contexts for the computed group members to name the group. Common contexts may include anything two or more people in the computed group may have in common, a common city, a common city of residence in the past, common college, common high school, common interests, activities done together by the members, and so forth. Based on available data, the groups may be automatically named in any of the following formats includes Initials of group members, Funny name compositions and so forth, animal names with funny adjectives (e.g., “Embarrassing pandas”, “Jabbering Jaguars”, etc.), Names reflecting common context among group members, “Chicago friends”, “UC Girls”, “Fierce Five”, “High school squad”, “Ex-California squad”, “The biking group”, “Canada vacation troupe” The computed groups are distributed to all group members. Any reward points and scores based on actions done by the group members are computed and stored along with relevant metadata. Metadata may include topics related to the filters or stickers or canvases used in the visual interactive story shared with the group, when it was shared, with whom it was shared, the location from which it was shared and other data.

The first dynamic group creation module 218 may be configured to suggest the groups to share the visual interactive story. These suggestions may be based on previous story shared, groups created, context of the user (e.g., where the user is, who is with the user, etc.), what is being shared and so forth. The visual interactive story is then distributed to the selected end-users. The step of distribution may involve sharing the visual interactive story to the cloud server 106 from the client device 102a and then distributing the visual interactive story to the end-user devices 102b, 102c . . . 102n over the network 104. The first dynamic group creation module 218 may be configured to compute the group composition to create a new group or to update an existing group based on the group of interactions between the creator and the group of end-users.

The first dynamic group eliminating module 220 may be configured to detect the group of end-users interacted to the visual interactive story shared by the creator and detects the group of end-users not interacted with the visual interactive story thereby eliminating the inactive end-users on the client device 102a. The first dynamic group eliminating module 220 may be configured to detect the lack of interaction among the end-users of existing groups. Based on this, the status of the group is computed. The status of the group may be same as current or revised (e.g., group marked for expiry) based on the length of inactivity detected in the group, the changes to group members' contexts, the general activity levels of group members with others or other criteria. If the group is inactive beyond a certain threshold, the group may be marked for expiry. The first dynamic group eliminating module 220 may be configured to alert the group members are alerted about the status change of the group. The step of alerting may involve explicitly sending a message to the group members or marking the group in visual ways on the first interactive story creation module 120a or a combination of both.

The first dynamic group eliminating module 220 may be configured to detect new activity in the group. This may involve detecting new visual interactive story shared among the group members or detecting any new interactions among the end-users. Upon such activity, the group is updated and no longer marked for expiry. Any reward points and scores based on actions done by the group of end-users are computed and stored along with relevant metadata. Metadata may include topics related to the filters or stickers or canvases used in the visual interactive story shared with the group, when it was shared, with whom it was shared, the location from which it was shared and other data. Alternatively, the first dynamic group eliminating module 220 may be configured to detect continued inactivity in the group. When the expiry threshold is reached, the group may be expired. The group is then removed from the end-user devices. Points associated with the expired groups may or may not be removed. If kept, these points may be applied if the group gets renewed within a given interval of time. The group may also be deleted at the cloud server 106. The first dynamic group eliminating module 220 may be configured to detect the active group of end-users interacted to the visual interactive story and the inactive group of end-users not interacted with the visual interactive story shared by the creator thereby eliminating the inactive group of end-users on the client device 102a.

The first gesture detecting module 222 may be configured to detect gestures performed on a viewed visual interactive story. An example of such a gesture is a long touch on the client device 102a. The longer the user holds the touch on the screen, the more the likes recorded. The continuation of a deep like gesture after a gap in the gesture may also be detected. For example, the creator may touch down on the first display 114a, lift finger and subsequently touch down again.

The first gesture detecting module 222 may be configured to render deep likes graphically to provide visual confirmation to the end-users. An example of visual confirmation may be the rendering of icons on the first display 114a. The icons rendered may be hearts of various colors. The icons may have an indication of any user levels or privileges in the system (e.g., flairs the creator may own at the time of liking the visual interactive story). When the end of the gesture is detected on the client device 102a, the average number of likes on that the visual interactive story may be revealed to the end-users, along with the relative number of likes the end-users has applied to the visual interactive story. The average and the relative position of the end-users likes may be drawn as a bar graph on the first display 114a. The end-users like count may be represented on the client device 102a by different colors depending on whether it is above or below the average number of likes. Further, this information may be temporarily displayed and removed without creator intervention.

In another embodiment, the median or a heat map may be displayed instead of the average. In yet another embodiment, a pie chart or other visualization may be displayed instead of a bar graph. The first gesture detecting module 222 may be configured to record number of likes applied by the creator for the corresponding visual interactive story shared by the end-users, the visual interactive story creator and the end-users applying the deep likes. The number of likes recorded may depend on the duration of time the gesture applied. For example, the longer the touch, the more likes are recorded. Any reward points and scores based on likes are computed and stored along with relevant metadata. The reward points may be applied to the corresponding the visual interactive story creator, the visual interactive story creator and the end-users applying the deep likes. Metadata may include topics related to the visual interactive story creator, filters or stickers or canvases used in the visual interactive story creator, when it was shared, with whom it was shared, the location from which it was shared and other data.

The like count is then distributed to the creator of the visual interactive story. When the visual interactive story is viewed again, the likes may be visually displayed to the end-users. The step of visually displaying the likes may involve replaying the deep like icons on the screen for a duration of time corresponding to the number of likes recorded. In an alternate embodiment, fewer number of icons may be displayed based on some multiple of the number of the likes recorded. In another embodiment of the invention, a counter may be displayed showing the number of likes recorded.

The first gesture detecting module 222 may be configured to detect the rich expressions performed by the creator on the visual interactive story with the gestures on the client device 102a and shares to the end-user devices 102b, 102c . . . 102n. The visual interactive story with the one or more media contents are displayed to the end-users. The first gesture detecting module 222 may be configured to detect the gesture for recording an expression. The gesture may be paused and continued and such a continuation of the gesture after a gap may also be detected. For example, the gesture may include a long touch on the first display 114a followed by drawing patterns on the first display 114a of the client device 102a. Based on the drawing patterns by the creator, an existing expression or a new expression may be detected. Examples of drawing patterns by the creator may include, but not limited to, Heart, One or more alphabets in a given language, Question mark, An emoticon, An exclamation mark, A check mark, A circle around a particular portion of the first story (e.g., a certain visible element in a photograph), and so forth. Based on such drawing patterns, the rich expressions shared and/or detected may include, “I love this photo!”, “You look great!”, “I love you”, “Don't like this much”, “Thinking of you”, “Proud of you”, Highlight a particular part of the first media content, for example, highlighting a particular object in the photo that the user likes, Voting for a particular option and so forth.

The first gesture detecting module 222 may be configured to detect the rich expression from a list of known rich expressions mapped to certain drawing patterns. These drawing patterns may be defined by the first interactive story creation module 120a or may be introduced by the creator. In the latter case, these patterns may only be known to the person expressing it (creator) and the people receiving it (end-users). The first gesture detecting module 222 may be configured to detect the drawing patterns of the gestures on the client device 102a and shares the rich expressions to the end-user devices 102b, 102c . . . 102n.

The first rewards calculating and scores generating module 224 may be configured to compute the visual interactive story shared with the end-users to generate reward points and scores and are stored along with relevant metadata. The metadata may include topics related to the digital graphical elements (filters or stickers or canvases) used in the first media content, when it was shared, with whom it was shared, the location from which it was shared and so forth.

In accordance with one or more exemplary embodiments of the present disclosure, the first interaction module 216 may be configured to enable the creator to view the visual interactive story shared by the end-users from the end-user devices 102b . . . 102n. The first interaction module 216 may also be configured to enable the creator to interact with the interactive story created by the end-users.

In accordance with one or more exemplary embodiments of the present disclosure, the second interactive story creation module 120b includes a bus 201b, a second profile module 226, a second media content capturing module 228, a second media content uploading module 230, a second context detecting module 232, second graphic elements suggesting module 234, and a second story creating module 236, a second story sharing module 238, a second interaction module 240, a second dynamic group creation module 242, a second dynamic group eliminating module 244, second gestures detecting module 246, and second rewards points calculating and scores generating module 248.

The second interactive story creation module 120b may be configured to receive the visual interactive story by the end-user devices 102b, 102c . . . 102d from the client device 102a over the network. The second interactive story creation module 120b includes the second profile module 226 may be configured to enable the end-users on the end-user devices 102b, 102c . . . 102n to create the end-user profiles. The second profile module 226 may be configured to transmit the end-user profiles of the end-users to the cloud server 106 and are stored in the cloud server 106.

The second media content capturing module 228 may be configured to enable the end-users to capture the second media content in real-time using the second camera of the end-user devices 102b, 102c . . . 102n and allows the end-users to add the second media content to the visual interactive story. The second media content uploading module 230 may also be configured to enable the end-users to add the second media content to the visual interactive story shared by the creator. The second media content may be stored in the second memory of the end-user devices 102b, 102c . . . 102n. The second context detecting module 232 may be configured to detect the second context of the end-user and suggests/displays the second graphical elements based on the second context of the end-users, second user profile, availability of sponsored canvases, general context (e.g., day of the week, new movie releases, TV shows, etc.) and so forth. The word sponsored in the context may include a person, a group, a merchant, business, trademark owner, brand owner or other similar entity may champion the display of specific multimedia content (a photograph, image, video, animated image, animated set of images, looping videos, looping images). The second digital graphical elements may include, but not limited to, canvases, stamps, stickers, filters doodle, and so forth. The second digital graphic elements may be in a static format, an animated format, a dynamic format, video graphic format and other related renditions and formats.

The second story creating module 236 may be configured to enable the end-users to progress the visual interactive story by uploading the second media content stored in the second memory of the end-user devices 102b, 102c . . . 102c or by capturing the second media content in real-time using the second camera. The second story sharing module 238 may be configured to enable the end-users to share the progressed visual interactive story with the other end-users or with the creator. The second dynamic group creation module 242 may be configured to enable the end-users to share the progressed visual interactive story created by the end-users with the selected group of the other end-users.

The second dynamic group creation module 242 may be configured to suggest the group of end-users to share the progressed visual interactive story. These suggestions may be based on previous story shared, groups created, context of the user (e.g., where the user is, who is with the user, etc.), what is being shared and so forth. The progressed visual interactive story is then distributed to the selected end-users. The step of distribution may involve sharing the progressed visual interactive story to the cloud server 106 which then distributes the progressed visual interactive story to the end-users. The second dynamic group eliminating module 244 may be configured to detect the group of end-users interacted to the progressed visual interactive story and detects the group of end-users not interacted with the progressed visual interactive story thereby eliminating the inactive end-users.

The second gesture detecting module 246 may be configured to detect gestures performed on the visual interactive story. An example of such a gesture is a long touch on the end-user devices 102b, 102c . . . 102n. The longer the user holds the touch on the screen, the more the likes recorded. The continuation of a deep like gesture after a gap in the gesture may also be detected. For example, the end-users may touch down on the second display 114b, lift finger and subsequently touch down again.

The second gesture detecting module 246 may be configured to render deep likes graphically to provide visual confirmation to the creator/the other end-users. An example of visual confirmation may be the rendering of icons on the second display 114b. The icons rendered may be hearts of various colors. The icons may have an indication of any user levels or privileges in the system (e.g., flairs the creator may own at the time of liking the visual interactive story). When the end of the gesture is detected on the end-user devices 102b, 102c . . . 102n, the average number of likes on that the visual interactive story may be revealed to the creator on the client device 102a, along with the relative number of likes the end-users has applied to the visual interactive story. The average and the relative position of the end-users likes may be drawn as a bar graph on the second display 114b. The end-users like count may be represented on the end-user devices 102b, 102c . . . 102n by different colors depending on whether it is above or below the average number of likes. Further, this information may be temporarily displayed and removed without end-users intervention.

In another embodiment, the median or a heat map may be displayed instead of the average. In yet another embodiment, a pie chart or other visualization may be displayed instead of a bar graph. The second gesture detecting module 246 may be configured to record number of likes applied by the end-users for the corresponding visual interactive story shared by the creator, and the end-users applying the deep likes. The number of likes recorded may depend on the duration of time the gesture applied. For example, the longer the touch, the more likes are recorded. Any reward points and scores based on likes are computed and stored along with relevant metadata. The reward points may be applied to the corresponding the visual interactive story creator, the visual interactive story creator and the end-users applying the deep likes. Metadata may include topics related to the visual interactive story creator, filters or stickers or canvases used in the visual interactive story creator, when it was shared, with whom it was shared, the location from which it was shared and other data.

The like count is then distributed to the creator of the visual interactive story. When the visual interactive story is viewed again, the likes may be visually displayed to the end-users. The step of visually displaying the likes may involve replaying the deep like icons on the second display 114a for a duration of time corresponding to the number of likes recorded. In an alternate embodiment, fewer number of icons may be displayed based on some multiple of the number of the likes recorded. In another embodiment of the invention, a counter may be displayed showing the number of likes recorded.

The second gestures detecting module 246 may be configured to detect the rich expressions performed by the end-users on the progressed visual interactive story with the gestures. The progressed visual interactive story with the one or more media contents are displayed to the other end-users. The second gesture detecting module 246 may be configured to detect the gesture for recording an expression. The gesture may be paused and continued and such a continuation of the gesture after a gap may also be detected. For example, the gesture may include a long touch on the second display 114b followed by drawing patterns on the second display 114b of the end-user devices 102b, 102c . . . 102d. Based on the drawing patterns drawn by the end-users on the end-user devices 102b, 102c . . . 102n, an existing expression or a new expression may be detected. Examples of drawing patterns drawn by the end-users may include, but not limited to, Heart, One or more alphabets in a given language, Question mark, An emoticon, An exclamation mark, A check mark, A circle around a particular portion of the first story (e.g., a certain visible element in a photograph), and so forth. Based on such patterns, the rich expressions shared and/or detected may include, “I love this photo!”, “You look great!”, “I love you”, “Don't like this much”, “Thinking of you”, “Proud of you”, Highlight a particular part of the first media content, for example, highlighting a particular object in the photo that the user likes, Voting for a particular option and so forth.

The second gesture detecting module 246 may be configured to detect the expression from a list of known expressions mapped to certain drawing patterns. These drawing patterns may be defined by the second interactive story creation module 120b or may be introduced by the end-users. In the latter case, these patterns may only be known to the person expressing it (end-users) and the people receiving it (creator).

The second rewards points calculating and scores generating module 248 may be configured to compute the visual interactive story shared with the end-users to generate reward points and scores and are stored in the cloud server 106 along with relevant metadata. The metadata may include topics related to the digital graphical elements (filters or stickers or canvases) used in the second media content, when it was shared, with whom it was shared, the location from which it was shared and so forth.

In accordance with one or more exemplary embodiments of the present disclosure, the second interaction module 240 may be configured to enable the end-users to view the visual interactive shared by the creator from the client device 102a. The second interaction module 240 may also be configured to enable the end-users to interact with the visual interactive story created by the creator thereby progressing the visual interactive story upon adding the second media content/second digital graphical elements to the visual interactive story on the end-user devices 102b, 102c . . . 102n.

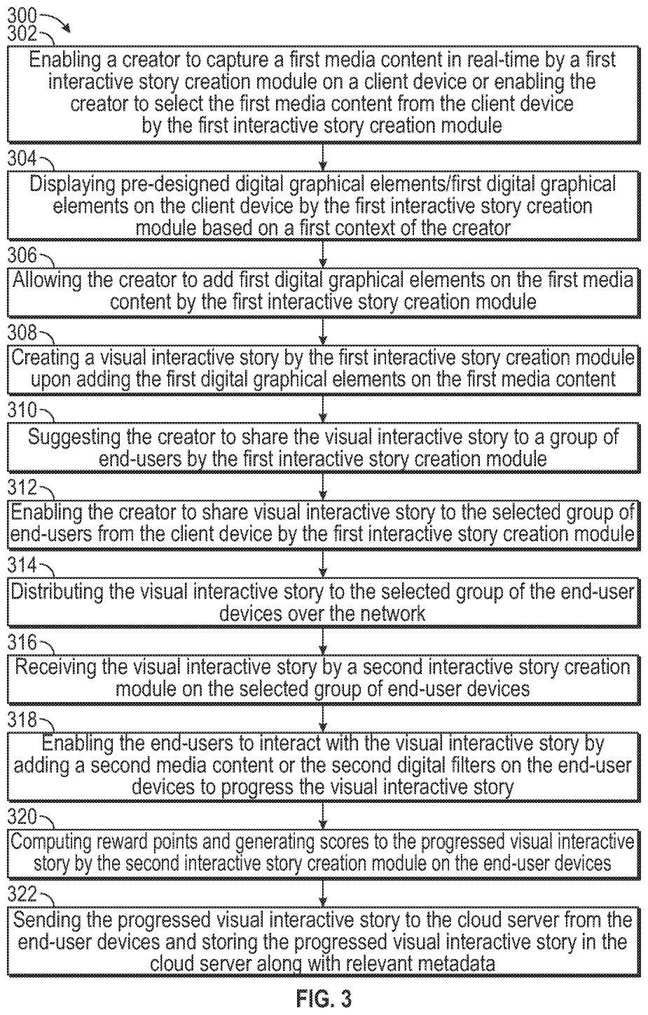

Referring to FIG. 3 is a flow diagram 300 depicting a method for creating a visual interactive story on a client device, in accordance with one or more exemplary embodiments. The method 300 may be carried out in the context of the details of FIG. 1, and FIG. 2. However, the method 300 may also be carried out in any desired environment. Further, the aforementioned definitions may equally apply to the description below.

The method commences at step 302, enabling the creator to capture the first media content in real-time by the first interactive story creation module on the client device or enabling the creator to select the first media content from the client device by the first interactive story creation module. Thereafter at step 304, displaying the pre-designed digital graphical elements/first digital graphical elements on the client device by the first interactive story creation module based on the first context of the creator. The first digital graphical elements shown may be based on the first context of the creator, the user profile, and availability of sponsored canvases, general context (e.g., day of the week, nee movie releases, TV shows, etc.) and so forth. The word sponsored in the first context may include the person, the group, the merchant, the business, the trademark owner, the brand owner or other similar entity may champion the display of specific multimedia content (a photograph, image, video, animated image, animated set of images, looping videos, looping images). For the act of sponsoring, the cost may be digital assets such as points within the system or monetary units inside or outside the application.

Thereafter at step 306, allowing the creator to add the first digital graphical elements on the first media content by the first interactive story creation module. The first digital graphical elements displayed may be based on the first context of the user, the user profile, and availability of sponsored filters, general context (e.g., day of the week, new movie releases, TV shows, etc.) or other criteria.

Thereafter at step 308, creating the visual interactive story by adding the first digital graphical elements on the first media content. Thereafter at step 310, suggesting the creator to share the visual interactive story to the group of end-users by the first interactive story creation module. In an alternate embodiment, the visual interactive story may be shared with everyone on the first interactive story creation module. These suggestions may be based on previous media shared, groups created, and context of the user (e.g., where the user is, who is with the user, etc.), what is being shared and other criteria.

Thereafter at step 312, enabling the creator to share the visual interactive story to the selected group of end-user devices from the client device by the first interactive story creation module. Thereafter at step 314, distributing the visual interactive story to the selected group of the end-user devices over the network.

Thereafter at step 316, receiving the visual interactive story by the second interactive story creation module on the selected group of end-user devices. Thereafter at step 318, enabling the end-users to interact with the visual interactive story by adding the second media content and/or the second digital filters on the end-user devices to progress the visual interactive story. Thereafter at step 320, computing the reward points and generating the scores to the visual interactive story by the second interactive story creation module on the end-user devices. Thereafter at step 322, sending the visual interactive story to the cloud server 106 from the end-user devices and storing the visual interactive story in the cloud server along with relevant metadata. The metadata may include topics related to the first and second digital graphical elements used in the first and second media content, when it was shared, with whom it was shared, the location from which it was shared and other data.

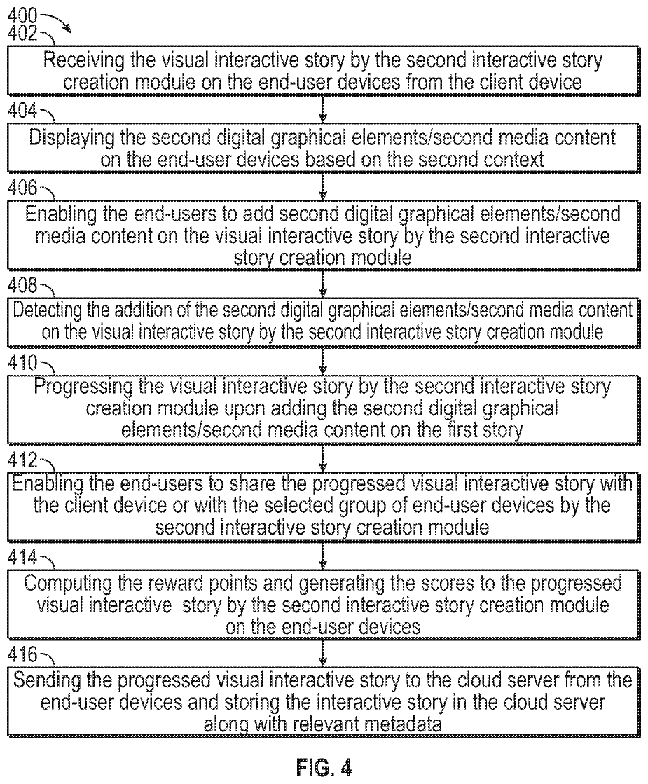

Referring to FIG. 4 is a flow diagram 400 depicting a method for interacting on the visual interactive story, in accordance with one or more exemplary embodiments. The method 400 may be carried out in the context of the details of FIG. 1, FIG. 2, and FIG. 3. However, the method 400 may also be carried out in any desired environment. Further, the aforementioned definitions may equally apply to the description below.

The method commences at step 402, receiving the visual interactive story by the end-user devices from the client device. Thereafter at step 404, displaying the second digital graphical elements/second media content on the end-user devices based on the second context. The second context may include the end-users profile data, availability of sponsored graphics, general context (e.g., day of the week, new movie releases, TV shows, etc.) or other criteria.

Thereafter at step 406, enabling the end-users to add second digital graphical elements/second media content on the visual interactive story by the second interactive story creation module. Thereafter at step 408, detecting the addition of the second digital graphical elements/second media content on the visual interactive story by the second interactive story creation module. Thereafter at step 410, progressing the visual interactive story by the second interactive story creation module upon adding the second digital graphical elements/second media content on the visual interactive story. Thereafter at step 412, enabling the end-users to share the progressed visual interactive story with the client device or with the selected group of end-user devices by the second interactive story creation module. Thereafter at step 414, computing the reward points and generating the scores to the progressed visual interactive story by the second interactive story creation module on the end-user devices. Thereafter at step 416, sending the progressed visual interactive story to the cloud server 106 from the end-user devices and storing the progressed visual interactive story in the cloud server along with relevant metadata.

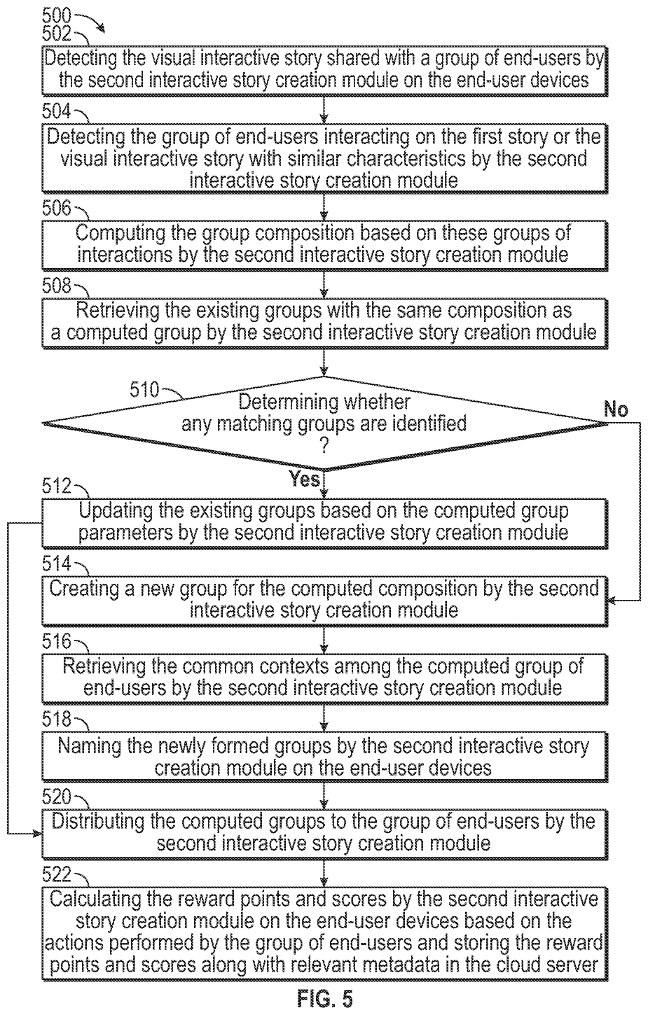

Referring to FIG. 5 is a flow diagram 500 depicting a method for dynamically detecting and creating a group from the interactions on the visual interactive stories happening among a group of people, in accordance with one or more exemplary embodiments. The method 500 may be carried out in the context of the details of FIG. 1, FIG. 2, FIG. 3, and FIG. 4. However, the method 500 may also be carried out in any desired environment. Further, the aforementioned definitions may equally apply to the description below.

The method commences at step 502, detecting the visual interactive story shared with a group of end-users by the second interactive story creation module on the end-user devices. Thereafter at step 504, detecting the group of end-users interacting on the visual interactive story by the second interactive story creation module. Thereafter at step 506, computing the group composition based on these groups of interactions by the second interactive story creation module. The step of computing group composition may include detecting the groups of users who repeatedly interact on the visual interactive story, groups of end-users who interact directly with each other, the same group of end-users being part of shared visual interactive story multiple times and so on. Thereafter at step 508, retrieving the existing groups with the same composition as the computed group by the second interactive story creation module. Determining whether any matching groups are identified?, at step 510. If answer at step 510 is Yes, Updating the existing groups based on the computed group parameters by the second interactive story creation module, at step 512.

If answer at step 510 is No, creating a new group for the computed composition by the second interactive story creation module, at step 514. Thereafter at step 516, retrieving the common contexts among the computed group of end-users by second interactive story creation module. The common contexts may include, two or more end-users in the computed group may be in common a common city, a common city of residence in the past, common college, common high school, common interests, activities done together by the members, and so forth.

Thereafter at step 518, naming the newly formed groups by the second interactive story creation module on the end-user devices. The naming the groups may be based on the available data, the groups may be automatically named in any of the following formats: Initials of group members, Funny name compositions—e.g., animal names with funny adjectives (e.g., “Embarrassing pandas”, “Jabbering Jaguars”, etc.), Names reflecting common context among group members, “Chicago friends”, “UC Girls”, “Fierce Five”, “High school squad”, “Ex-California squad”, “The biking group” “Canada vacation troupe”, and so forth. Thereafter at step 520, distributing the computed groups to the group of end-users by the second interactive story creation module. Thereafter at step 522, calculating the reward points and scores by the second interactive story creation module on the end-user devices based on the actions performed by the group of end-users and storing the reward points and scores along with relevant metadata in the cloud server.

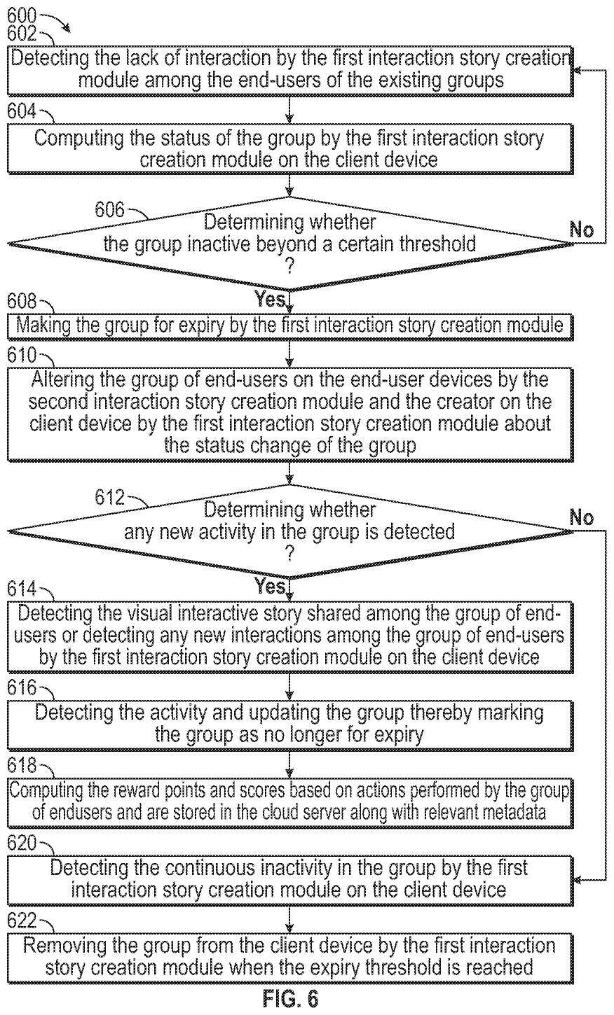

Referring to FIG. 6 is a flow diagram 600 depicting a method for dynamically detecting and expiring inactive groups and/or updating the groups based on the new interactions, in accordance with one or more exemplary embodiments. The method 600 may be carried out in the context of the details of FIG. 1, FIG. 2, FIG. 3, FIG. 4, and FIG. 5. However, the method 600 may also be carried out in any desired environment. Further, the aforementioned definitions may equally apply to the description below.

The method commences at step 602, detecting the lack of interaction by the first interaction story creation module among the end-users of the existing groups. Thereafter at step 604, computing the status of the group by the first interaction story creation module on the client device. The status of the group may be same as current or revised (e.g., group marked for expiry) based on the length of inactivity detected in the group, the changes to group members contexts, the general activity levels of group members with others on the first interaction story creation module/second interaction story creation module or other criteria. Determining whether the group is inactive beyond a certain threshold? at step 606. If the answer at 606 is Yes, the method commence at step 608, marking the group for expiry. Thereafter at step 610, altering the group of end-users on the end-user devices by the second interaction story creation module and the creator on the client device by the first interaction story creation module about the status change of the group. The step of alerting may include sending a message to the group members or marking the group in visual ways in the first interaction story creation module/the second interaction story creation module on the client device and the end-user devices or a combination of both. If the answer at step 606 is No, the method reverts at step 602. Determining whether any new activity in the group is detected? at step 612. If the answer at step 612 is Yes, the method continues at step 614, detecting the interactive story shared among the group of end-users or detecting any new interactions among the group of end-users by the first interaction story creation module on the client device. Thereafter at step 616, detecting the activity and updating the group thereby marking the group as no longer for expiry. Thereafter at step 618, computing the reward points and scores based on actions performed by the group of end-users and are stored along with relevant metadata. If the answer at step 612 is No, the method continues at step 620, detecting the continuous inactivity in the group by the first interaction story creation module on the client device. The method continues at step 622, removing the group from the client device by the first interaction story creation module when the expiry threshold is reached. The reward points associated with the expired groups may or may not be removed. If saved in the cloud server, these points may be applied if the group gets renewed within a given interval of time. The group may also be deleted at the cloud server.

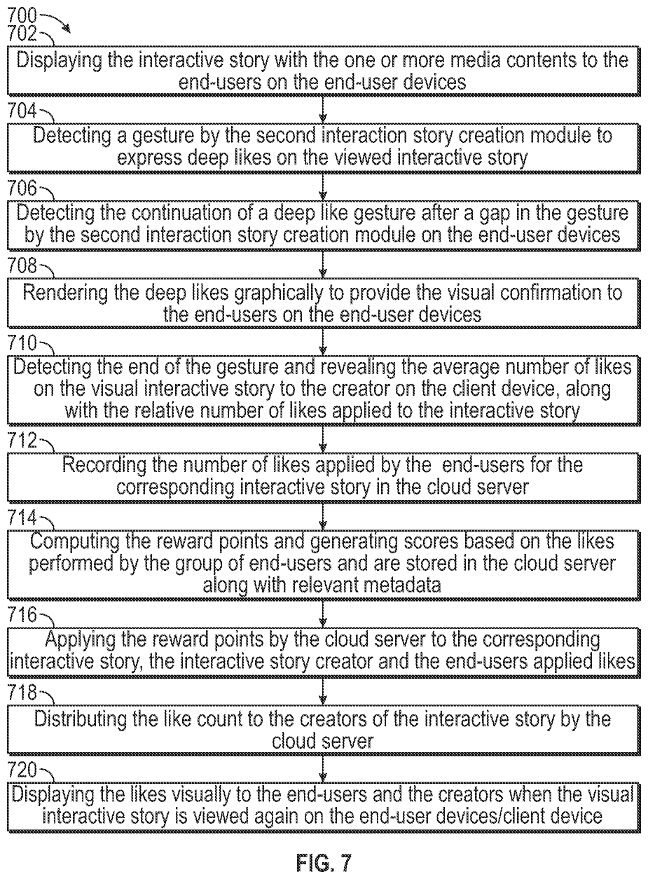

Referring to FIG. 7 is a flow diagram 700 depicting a method for expressing deep likes on the interactive stories shared with the end-users, in accordance with one or more exemplary embodiments. The method 700 may be carried out in the context of the details of FIG. 1, FIG. 2, FIG. 3, FIG. 4, FIG. 5, and FIG. 6. However, the method 700 may also be carried out in any desired environment. Further, the aforementioned definitions may equally apply to the description below.

The method commences at step 702, displaying the visual interactive story with the one or more media contents to the end-users on the end-user devices. Thereafter at step 704, detecting a gesture by the second interaction story creation module to express deep likes on the viewed interactive story. An example of such a gesture is a long touch on a touchscreen device. The longer the user holds the touch on the screen, the more the likes recorded. Thereafter at step 706, detecting the continuation of a deep like gesture after a gap in the gesture by the second interaction story creation module on the end-user devices. For example, the end-user may touch down on the screen, lift finger and subsequently touch down again. Thereafter at step 708, rendering the deep likes graphically to provide the visual confirmation to the end-users on the end-user devices. An example of the visual confirmation may be the rendering of icons on the screen. The icons rendered may be hearts of various colors. The icons may have an indication of any user levels or privileges in the system (e.g., flairs the user may own at the time of liking the media). Thereafter at step 710, detecting the end of the gesture and revealing the average number of likes on the visual interactive story to the creator, along with the relative number of likes the end-user has applied to the interactive story.

The average and the relative position of the end-users likes may be drawn as a bar graph on the screen. The end-users like count may be represented by different colors depending on whether it is above or below the average number of likes. Further, this information may be temporarily displayed and removed without user intervention. In another embodiment, the median or a heat map may be displayed instead of the average. In yet another embodiment, a pie chart or other visualization may be displayed instead of a bar graph.

Thereafter at step 712, recording the number of likes applied by the end-users for the corresponding interactive story of the creator. The number of likes recorded may depend on the duration of time the gesture was applied. For example, the longer the touch, the more likes are recorded. Thereafter at step 714, computing the reward points and generating scores based on the likes performed by the group of end-users and are stored along with relevant metadata. Thereafter at step 716, applying the reward points to the corresponding interactive story, the interactive story creator and the end-users applied the deep likes. Thereafter at step 718, distributing the like count to the recipients (creators) of the visual interactive story. Thereafter at step 720, displaying the likes visually to the end-users when the interactive story is viewed again. The step of visually displaying the likes may involve replaying the deep like icons on the screen for a duration of time corresponding to the number of likes recorded. In an alternate embodiment, fewer number of icons may be displayed based on some multiple of the number of the likes recorded. In another embodiment of the invention, a counter may be displayed showing the number of likes recorded.

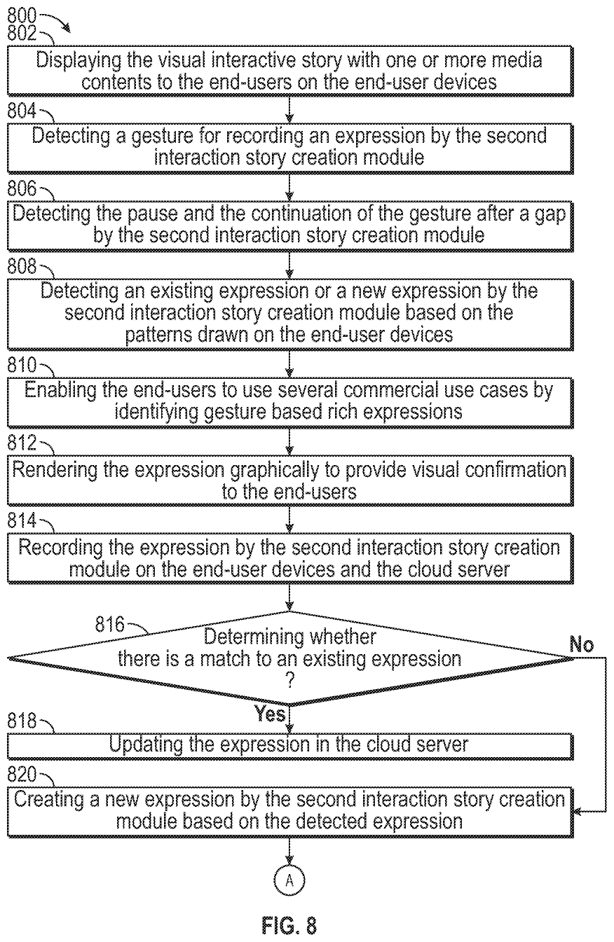

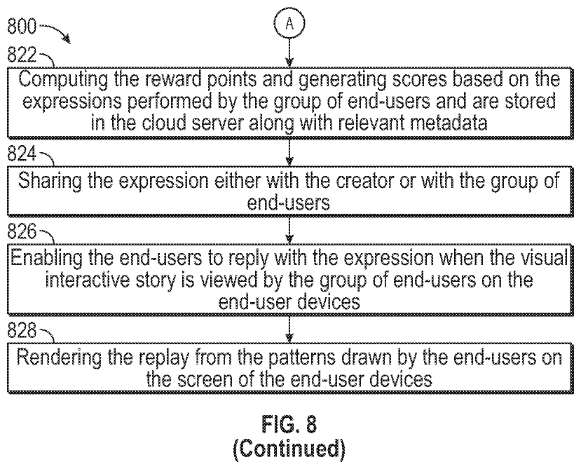

Referring to FIG. 8 is a flow diagram 800 depicting a method for sharing rich expressions on the visual interactive story with the gestures and replaying the expressions to the end-users, in accordance with one or more exemplary embodiments. The method 800 may be carried out in the context of the details of FIG. 1, FIG. 2, FIG. 3, FIG. 4, FIG. 5, FIG. 6 and FIG. 7. However, the method 800 may also be carried out in any desired environment. Further, the aforementioned definitions may equally apply to the description below.

The method commence at step 802, displaying the visual interactive stories with media contents to the end-users on the end-user devices. Thereafter at step 804, recording an expression upon detecting a gesture performed by the end-users on the end-user devices using the second interaction story creation module. Thereafter at step 806, detecting the pause and the continuation of the gesture after a gap by the second interaction story creation module on the end-user devices. For example, a gesture may involve a long touch on the screen followed by drawing patterns on the screen. Thereafter at step 808, detecting an existing expression or a new expression by the second interaction story creation module based on the patterns drawn on the end-user devices. Examples of patterns drawn on the end-user devices that may be detected by the second interaction story creation module may include, Heart, One or more alphabets in a given language, Question mark, An emoticon, An exclamation mark, A check mark, A circle around a particular portion of the media content (e.g., a certain visible element in a photograph) and so forth. Based on such patterns, the following expressions may be shared and/or detected: “I love this photo!”, “You look great!”, “I love you”, “Don't like this much”, “Thinking of you”, “Proud of you”, Highlight a particular part of the media content for example, highlighting a particular object in the photo that the user likes, Voting for a particular option, and so forth. The step of detecting the expression may involve looking up a list of known expressions mapped to certain patterns. These patterns may be defined by the system or may be introduced by the end-users. In the latter case, these patterns may only be known to the end-user expressing it and the creator receiving it.

Thereafter at step 810, enabling the end-users to use several commercial use cases by identifying the gesture based on the rich expressions. The commercial use cases may include, Sensing the sentiment of the population on a new product, style, and so forth, Asking people for opinions on colors preferred, say for a new apparel being introduced, Allowing the public to choose the preferred style—say, with multiple accessory choices included, Assessing sentiment on public topics—e.g., a presidential candidate, a campaign, etc.

Thereafter at step 812, rendering the expression graphically by the second interaction story creation module on the end-user devices to provide visual confirmation to the end-users. An example of visual confirmation may be the rendering of icons on the screen in the pattern drawn. Thereafter at step 814, recording the expression on the end-user device and the cloud server. Determining whether there is a match to an existing expression?, at step 816. If answer at step 816 is Yes, updating the expression in the cloud server. If answer at step 816 is No, thereafter at step 818, creating a new expression by the second interaction story creation module based on the detected expression.

Thereafter at step 820, computing the reward points and generating scores based on the expressions performed by the group of end-users and are stored in the cloud server along with relevant metadata. The reward points may be applied to the corresponding interactive story, the story creator and the user adding the expression. The number of reward points may depend on the time taken to draw the expression and the type of expression itself, among other factors. The metadata may include topics related to the media, filters or stickers or canvases used in the media, when it was shared, with whom it was shared, the location from which it was shared and other data. Thereafter at step 822, sharing the expression either with just the creator or with the group of end-users. Thereafter at step 824, enabling the end-users to reply with the expression when the visual interactive story is viewed by the group of end-users on the end-user devices. Thereafter at step 826, rendering the replay from the patterns drawn by the end-users on the screen of the end-user devices.

Overall, the interactive stories may enable several use cases including but not limited to, friends hanging out together at the same place creating a story with photos from their own devices, Friends from different places interacting on a story around a topic, Multiple users (friends or others) interacting on a story around a topic—for example, discussing a Game Of Thrones episode or discussing an alternate ending for a movie or discussing a trend or a look, a political candidate and so on. Brands creating stories with consumer participation—for example, Adidas creating a “Race with Adidas” story, invoking participation from people wearing Adidas gear and participating in races. Brands getting opinions on new products or their missions or other efforts from their consumers and friends of consumers.

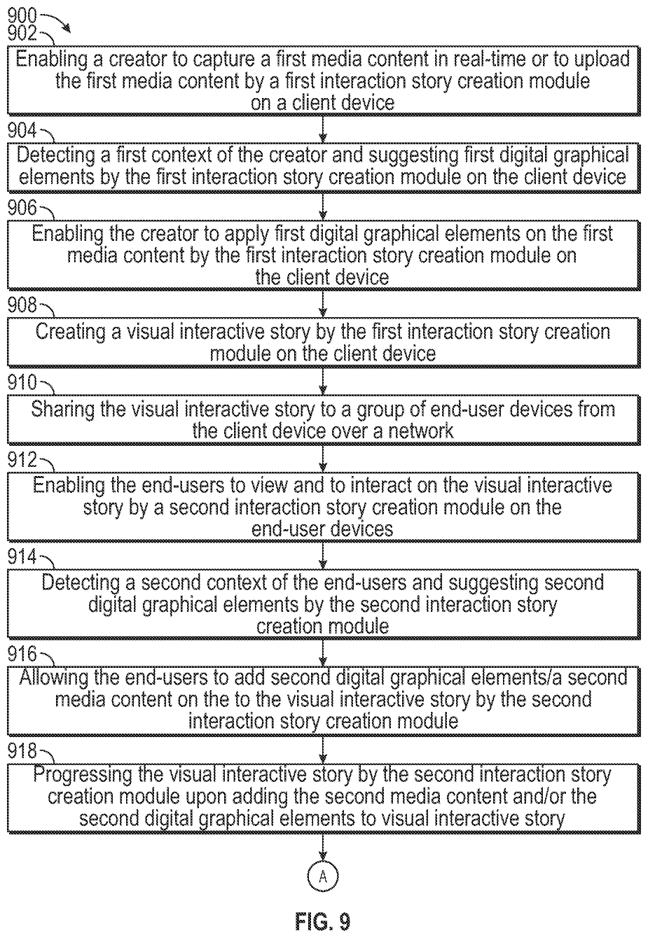

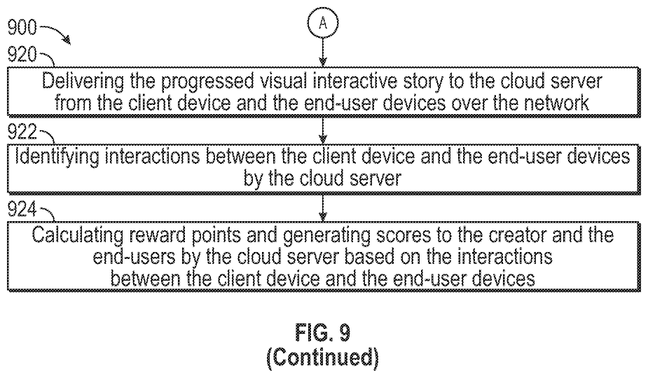

Referring to FIG. 9 is a flow diagram 900 depicting a method for creating and progressing a visual interactive story on computing devices, in accordance with one or more exemplary embodiments. The method 900 may be carried out in the context of the details of FIG. 1, FIG. 2, FIG. 3, FIG. 4, FIG. 5, FIG. 6, and FIG. 7, and FIG. 8. However, the method 900 may also be carried out in any desired environment. Further, the aforementioned definitions may equally apply to the description below.

The method commences at step 902, enabling a creator to capture a first media content in real-time or to upload the first media content by a first interaction story creation module on a client device. Thereafter at step 904, detecting a first context of the creator and suggesting first digital graphical elements by the first interaction story creation module on the client device. Thereafter at step 906, enabling the creator to apply first digital graphical elements on the first media content by the first interaction story creation module. Thereafter at step 908, creating the first story by the first interaction story creation module on the client device. Thereafter at step 910, sharing the first story to a group of end-user devices from the creator device over a network. Thereafter at step 912, enabling the end-users to view and to interact on the first story by a second interaction story creation module on the end-user devices. Thereafter at step 914, enabling the end-users to add a second media content to the first story by the second interaction story creation module. Thereafter at step 916, detecting a second context of the end-users and suggesting second digital graphical elements by the second interaction story creation module. Thereafter at step 918, allowing the end-users to apply second digital graphical elements on the second media content by the second interaction story creation module. Thereafter at step 920, creating an interactive story by the second interaction story creation module upon adding the second media content and/or the second digital graphical elements to the first story. Thereafter at step 922, delivering the first story and the interactive to the cloud server from the client device and the end-user devices over the network. Thereafter at step 924, identifying the interaction between the client device and the end-user devices by the cloud server. Thereafter at step 926, calculating reward points and generating scores to the creator and the end-users by the cloud server based on the interaction between the client device and the end-user devices. Thereafter at step 928, storing the first story and the interactive story in the cloud server along with relevant metadata.

Referring to FIG. 10 is a block diagram 1000 illustrating the details of a digital processing system 1000 in which various aspects of the present disclosure are operative by execution of appropriate software instructions. The Digital processing system 1000 may correspond to the client device 102a and the end-user devices 102b, 102c . . . 102n (or any other system in which the various features disclosed above can be implemented).

Digital processing system 1000 may contain one or more processors such as a central processing unit (CPU) 1010, random access memory (RAM) 1020, secondary memory 1030, graphics controller 1060, display unit 1070, network interface 1080, and input interface 1090. All the components except display unit 1070 may communicate with each other over communication path 1050, which may contain several buses as is well known in the relevant arts. The components of FIG. 10 are described below in further detail.

CPU 1010 may execute instructions stored in RAM 1020 to provide several features of the present disclosure. CPU 1010 may contain multiple processing units, with each processing unit potentially being designed for a specific task. Alternatively, CPU 1010 may contain only a single general-purpose processing unit.

RAM 1020 may receive instructions from secondary memory 1030 using communication path 1050. RAM 1020 is shown currently containing software instructions, such as those used in threads and stacks, constituting shared environment 1025 and/or user programs 1026. Shared environment 1025 includes operating systems, device drivers, virtual machines, etc., which provide a (common) run time environment for execution of user programs 1026.

Graphics controller 1060 generates display signals (e.g., in RGB format) to display unit 1070 based on data/instructions received from CPU 1010. Display unit 1070 contains a display screen to display the images defined by the display signals. Input interface 1090 may correspond to a keyboard and a pointing device (e.g., touch-pad, mouse) and may be used to provide inputs. Network interface 1080 provides connectivity to a network (e.g., using Internet Protocol), and may be used to communicate with other systems (such as those shown in FIG. 1) connected to the network 104.

Secondary memory 1030 may contain hard drive 1035, flash memory 1036, and removable storage drive 1037. Secondary memory 1030 may store the data software instructions (e.g., for performing the actions noted above with respect to the Figures), which enable digital processing system 1000 to provide several features in accordance with the present disclosure.

Some or all of the data and instructions may be provided on removable storage unit 1040, and the data and instructions may be read and provided by removable storage drive 1037 to CPU 1010. Floppy drive, magnetic tape drive, CD-ROM drive, DVD Drive, Flash memory, removable memory chip (PCMCIA Card, EEPROM) are examples of such removable storage drive 1037.

Removable storage unit 1040 may be implemented using medium and storage format compatible with removable storage drive 1037 such that removable storage drive 1037 can read the data and instructions. Thus, removable storage unit 1040 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 1040 or hard disk installed in hard drive 1035. These computer program products are means for providing software to digital processing system 1000. CPU 1010 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 1030. Volatile media includes dynamic memory, such as RAM 1020. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus (communication path) 1050. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub-combinations of the various features described hereinabove as well as variations and modifications thereof, which would occur to persons skilled in the art upon reading the foregoing description.

What is claimed is:

1. A system for creating and progressing visual interactive stories on computing devices, comprising:
a client device and one or more end-user devices configured to establish communication with a cloud server over a network, the client device comprises a first processor, a first memory, a first camera, a first display, a first audio output, and a first audio input;
the first processor comprises a first interactive story creation module and is stored in the first memory of the client device, the first interactive story creation module configured to enable a creator to capture a first media content in real-time using the first camera, and the first audio input;
the first interactive story creation module configured to enable the creator to upload at least one of: the first media content stored in the first memory of the client device; and the first media content captured in real-time, the first interactive story creation module configured to identify a first context of the creator and suggests one or more first digital graphical elements on the client device, the first interactive story creation module also configured to enable the creator to add the one or more first digital graphical elements on the first media content to create a visual interactive story and shares the visual interactive story to the cloud server and the one or more end-user devices over the network;
the one or more end-user devices comprises a second interactive story creation module configured to display the visual interactive story shared by the creator from the client device and enables one or more end-users to interact with the visual interactive story on the one or more end-user devices, the second interactive story creation module configured to enable the one or more end-users to upload at least one of: a second media content stored in a second memory of the one or more end-user devices; and the second media content captured in real-time; and
the second interactive story creation module configured to identify a second context of the one or more end-users and suggests one or more second digital graphical elements to the one or more end-users on the one or more end-user devices, the second interactive story creation module configured to enable the one or more end-users to progress the visual interactive story by adding at least one of: the one or more second digital graphical elements; and the second media content; on the visual interactive story shared by the creator thereby progressing one or more visual interactive stories on the one or more end-user devices and shares the one or more progressed visual interactive stories to the cloud server over the network.

2. The system of claim 1, wherein the first interactive story creation module comprises a first graphic elements suggesting module configured to suggest the one or more first graphical elements based on the first context of the creator, user profile, availability of sponsored canvases, and a general context.

3. The system of claim 1, wherein the first interactive story creation module comprises a first dynamic group creation module is configured to detect the visual interactive story shared by the creator with a selected group of the end-users and a group of end-users interacting on the same visual interactive story with similar characteristics.

4. The system of claim 1, wherein the first dynamic group creation module is configured to compute a group composition to create a new group or to update an existing group based on a group of interactions between the creator and the group of end-users.

5. The system of claim 3, wherein the first dynamic group creation module is configured to suggest one or more groups on the client device to share the visual interactive story to the one or more end-user devices based on at least one of: the previous visual interactive story shared by the creator; groups created by the creator; and the first context of the creator.

6. The system of claim 1, wherein the first interactive story creation module comprises a first dynamic group eliminating module is configured to detect an active group of end-users interacted to the visual interactive story and an inactive group of end-users not interacted with the visual interactive story shared by the creator thereby eliminating the inactive group of end-users on the client device.

7. The system of claim 1, wherein the first dynamic group eliminating module is configured to detect at least one of: new visual interactive story shared among the group of end-users; and any new interactions among the group of end-users and marking the group of end-users as no longer marked for expiry.

8. The system of claim 1, wherein the first interactive story creation module comprises a first gesture detecting module is configured to detect one or more gestures performed on the visual interactive story on the client device to record one or more rich expressions.

9. The system of claim 8, wherein the first gesture detecting module is configured to detect one or more drawing patterns of the one or more gestures on the client device and shares the one or more rich expressions to the one or more end-user devices.

10. The system of claim 1, wherein the first interactive story creation module comprises a first rewards calculating and scores generating module is configured to compute the visual interactive story shared with the one or more end-users devices from the client device.

11. The system of claim 10, wherein the first rewards calculating and scores generating module is configured to generate one or more reward points and scores based on the computed visual interactive story shared with the one or more end-users devices and stores the one or more reward points and scores along with a relevant metadata in the cloud server.

12. The system of claim 1, wherein the first interactive story creation module comprises a first interaction module is configured to enable the creator to view and to interact with the visual interactive story shared by the one or more end-users from the end-user devices.

13. The system of claim 1, wherein the second interactive story creation module comprises a second graphic elements suggesting module is configured to suggest the one or more second graphical elements based on at least one of: the second context of the end-users; second user profile; availability of sponsored canvases; and a general context of the end-users.

14. The system of claim 1, wherein the second interactive story creation module comprises a second story creating module is configured to enable the one or more end-users to create the one or more visual interactive stories by uploading at least one of: the second media content stored in the second memory of the one or more end-user devices; and by capturing the second media content in real-time using the second camera.

15. The system of claim 14, wherein the second story sharing module is configured to enable the one or more end-users to share the one or more interactive stories with at least one of: the client device; and the one or more end-user devices over the network in at least one of: public; in private.

16. The system of claim 1, wherein the second interactive story creation module comprises a second gesture detecting module is configured to detect one or more gestures performed on the one or more visual interactive stories on the one or more end-user devices to record one or more rich expressions.

17. The system of claim 16, wherein the second gesture detecting module is configured to detect drawing patterns of the one or more gestures on the one or more end-user devices and shares the one or more rich expressions to at least one of: the client device; and the one or more end-user devices.

18. The system of claim 1, wherein the second interactive story creation module comprises a second rewards calculating and scores generating module is configured to compute the one or more visual interactive stories shared with at least one of: the client device; and the one or more end-users devices.

19. The system of claim 18, wherein the second rewards calculating and scores generating module is configured to generate one or more reward points and scores based on the one or more progressed visual interactive stories shared to at least one of: the client device; and the one or more end-users devices; and stores the one or more reward points and scores along with relevant metadata in the cloud server.

20. A method for creating and progressing visual interactive stories on computing devices, comprising:
enabling a creator to upload at least one of: a first media content stored in a first memory of the client device; and the first media content captured in real-time;
identifying a first context of the creator and suggesting one or more first digital graphical elements by a first interactive story creation module on the client device;
enabling the creator to add the one or more first digital graphical elements on the first media content to create a visual interactive story by the first interactive story creation module;
sharing the visual interactive story to the cloud server and the one or more end-user devices over the network;
enabling one or more end-users to interact with the visual interactive story by a second interactive story creation module on the one or more end-user devices;
enabling the one or more end-users to upload at least one of: a second media content stored in the second memory of the one or more end-user devices; and the second media content captured in real-time by the second interactive story creation module
identifying a second context of the one or more end-users and suggesting one or more second digital graphical elements to the one or more end-users by the second interactive story creation module on the one or more end-user devices;
enabling the one or more end-users to progress the visual interactive story by adding at least one of: the one or more second digital graphical elements; and the second media content; by the second interactive story creation module; and
progressing one or more visual interactive stories on the one or more end-user devices and shares the one or more progressed visual interactive stories to the cloud server over the network.

21. A computer program product comprising a non-transitory computer-readable medium having a computer-readable program code embodied therein to be executed by one or more processors, said program code including instructions to:
enable a creator to upload at least one of: a first media content stored in a first memory of the client device; and the first media content captured in real-time;
identify a first context of the creator and suggest one or more first digital graphical elements a first interactive story creation module on the client device;
enable the creator to add the one or more first digital graphical elements on the first media content to create a visual interactive story by the first interactive story creation module;
share the visual interactive story to the cloud server and the one or more end-user devices over the network;
enable one or more end-users to interact with the visual interactive story by a second interactive story creation module on the one or more end-user devices;
enable the one or more end-users to upload at least one of: a second media content stored in the second memory of the one or more end-user devices; and the second media content captured in real-time; by the second interactive story creation module
identify a second context of the one or more end-users and suggest one or more second digital graphical elements to the one or more end-users by the second interactive story creation module on the one or more end-user devices;
enable the one or more end-users to progress the visual interactive story by adding at least one of: the one or more second digital graphical elements; and the second media content; by the second interactive story creation module; and
progress one or more visual interactive stories on the one or more end-user devices and share the one or more progressed visual interactive stories to the cloud server over the network.
